(19) United States
(12) Patent Application Publication
(10) Pub. No.: US 2013/0201702 A1
(43) Pub. Date: Aug. 8, 2013

(54) GOOSENECK FLOODLIGHT EXTENSION

(71) Applicant: Thomas Wallon, Jacksonville, FL (US)

(72) Inventor: Thomas Wallon, Jacksonville, FL (US)

(21) Appl. No.: 13/761,588

(22) Filed: Feb. 7, 2013

Related U.S. Application Data
(60) Provisional application No. 61/596,084, filed on Feb. 7, 2012.

(51) Int. Cl. F21V 21/32

(52) U.S. Cl. CPC F21V 21/32
USPC 362/418

(57) ABSTRACT

A gooseneck floodlight extension that includes a flexible gooseneck made with a weather resistant exterior material, a standard female light socket with a weather resistant cover attached to a first end of the flexible gooseneck, a standard male light base attached to a second end of the flexible gooseneck with a weather resistant cover and an electrical wire connecting the standard male light base and the female light socket. The gooseneck floodlight extension provides user flexibility in choosing which areas to light and allows existing floodlight fixtures to be utilized, even though they may have lost their adjustability and directionality and allows unobstructed light to be shown by reaching around blockages like newly installed gutters, trees and other obstructions.

This application claims priority to U.S. Provisional Application 61/596,084 filed on Feb. 7, 2012, the entire disclosure of which is incorporated by reference.

### BACKGROUND OF THE INVENTION

1. Field of the Invention

The present invention is a floodlight extension. More specifically, the present invention is a gooseneck floodlight extension.

2. Description of the Related Art

Millions of homes in the United States and elsewhere have exterior flood light mounts that become no longer adjustable, due to corrosion, rust, oxidation and other factors. Some have been partially covered by eve troughs that were added later and block part of a generated light source.

The present invention restores the ability to direct a light source to any direction desired. The present invention includes a flexible gooseneck that is weather resistant, has a standard male electrical base attached to a first end and is connected via a wire carrying electricity to a female light socket at a second end. The present invention allows removing an existing flood light that is screwed in a male end of the flexible gooseneck extension, screwing in an existing light or a new light into a female light socket and bending the flexible gooseneck extension in the preferred direction, allowing light to areas not lit or only partially lit. The present invention gives an occupant of a home an ability to shine light on any desired area within a generated light's capability.

### BRIEF SUMMARY OF THE INVENTION

The present invention is a floodlight extension. More specifically, the present invention is a gooseneck floodlight extension.

The gooseneck floodlight extension includes a flexible gooseneck made with a weather resistant exterior material, a standard female light socket with a weather resistant cover attached to a first end of the flexible gooseneck, a standard male light base attached to a second end of the flexible gooseneck with a weather resistant cover and an electrical wire connecting the standard male light base and the female light socket.

The gooseneck floodlight extension provides user flexibility in choosing which areas to light and allows existing floodlight fixtures to be utilized, even though they may have lost their adjustability and directionality and allows unobstructed light to be shown by reaching around blockages like newly installed gutters, trees and other obstructions.

It is an object of the present invention to provide a gooseneck floodlight extension that can be maneuvered around one or more obstructions such as one or more trees and one or more gutters.

It is an object of the present invention to provide a gooseneck floodlight extension that is resistant against weather.

It is an object of the present invention to provide a gooseneck floodlight extension with a standard female light socket that is resistant against weather.

### BRIEF DESCRIPTION OF THE DRAWINGS

The present invention will be described by way of exemplary embodiments, but not limitations, illustrated in the accompanying drawings in which like references denote similar elements, and in which:

FIG. 1 illustrates a side perspective view of a gooseneck floodlight extension, in accordance with one embodiment of the present invention.

FIG. 2 illustrates a front perspective view of a gooseneck floodlight extension, in accordance with one embodiment of the present invention.

### DETAILED DESCRIPTION OF ILLUSTRATIVE EMBODIMENTS

Various aspects of the illustrative embodiments will be described using terms commonly employed by those skilled in the art to convey the substance of their work to others skilled in the art. However, it will be apparent to those skilled in the art that the present invention may be practiced with only some of the described aspects. For purposes of explanation, specific numbers, materials and configurations are set forth in order to provide a thorough understanding of the illustrative embodiments. However, it will be apparent to one skilled in the art that the present invention may be practiced without the specific details. In other instances, well-known features are omitted or simplified in order not to obscure the illustrative embodiments.

Various operations will be described as multiple discrete operations, in turn, in a manner that is most helpful in understanding the present invention, however, the order of description should not be construed as to imply that these operations are necessarily order dependent. In particular, these operations need not be performed in the order of presentation.

The phrase “in one embodiment” is used repeatedly. The phrase generally does not refer to the same embodiment, however, it may. The terms “comprising”, “having” and “including” are synonymous, unless the context dictates otherwise.

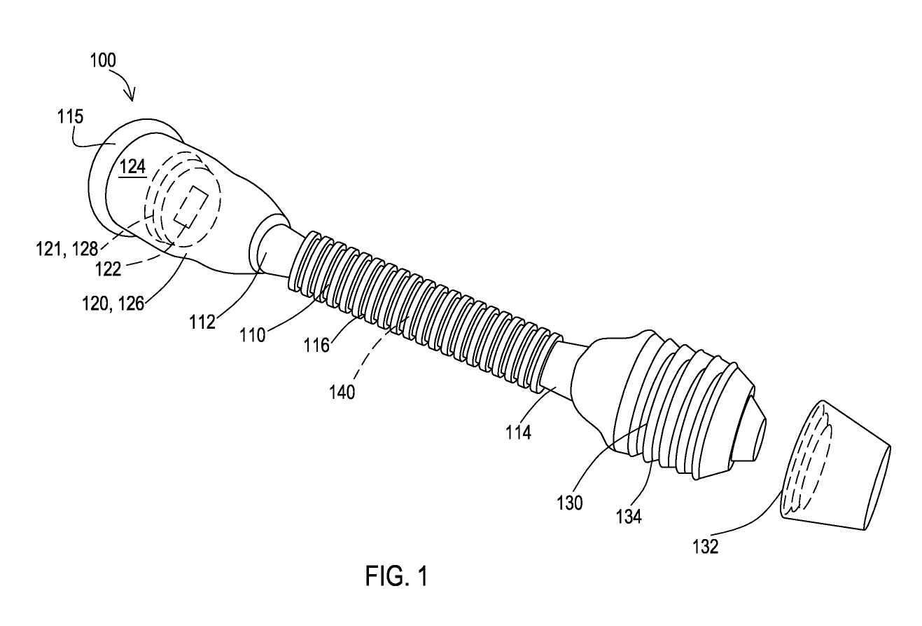

FIG. 1 illustrates a side perspective view of a gooseneck floodlight extension 100, in accordance with one embodiment of the present invention.

The gooseneck floodlight extension 100 includes a flexible gooseneck 110, a female light socket 120, a male light base 130 and one or more electrical wires 140. The flexible gooseneck 110 includes a first end 112 and a second end 114. The flexible gooseneck 110 allows a user to bend the gooseneck floodlight extension 100 to position a light 115 emitted from the gooseneck floodlight extension 100. The flexible gooseneck 110 is made with a third weather resistant cover 116 such as metal, stainless steel, plastic or other suitable material to protect the flexible gooseneck 110. The female light socket 120 is a standard female light socket 122 with a first weather resistant cover 124 attached to a first end 112 of the flexible gooseneck 110 to protect the female light socket 120. The female light socket 120 receives a light bulb 121 that emits the light 115 emitted from the gooseneck floodlight extension 100. The female light socket 120 can be a standard female light socket (not shown) that receives a standard light bulb (not shown), an E-27 standard female light socket 126 that receives an E-27 standard light bulb 128 or any suitable female light socket that receives any suitable light bulb. The male light base 130 is attached to the second end 114 of the flexible gooseneck 110. The male light base 130 is screwed into a floodlight socket 132 and receives electric power from the floodlight socket 132. The male light base 130 is provided with a second weather resistant cover 134 such as metal, stainless steel, plastic or other suitable material to protect the male light base 130. The one or more electrical wires 140 are connected to the male light base 130 and the female light socket 120. The one or more electrical wires 140 transfer electrical energy from the male light base 130 and to the female light socket 120 to light the light bulb 121 in the female light socket 120 that emits the light 115 emitted from the gooseneck floodlight extension 100. The gooseneck floodlight extension 100 is approximately 26 cm in length when fully extended but can be any suitable length.

In one embodiment of the gooseneck floodlight extension, the gooseneck floodlight extension can be maneuvered around one or more obstructions such as one or more trees and one or more gutters.

In one embodiment of the gooseneck floodlight extension, the gooseneck floodlight extension is resistant against weather.

In another embodiment of the gooseneck floodlight extension, the gooseneck floodlight extension has a standard female light socket that is resistant against weather.

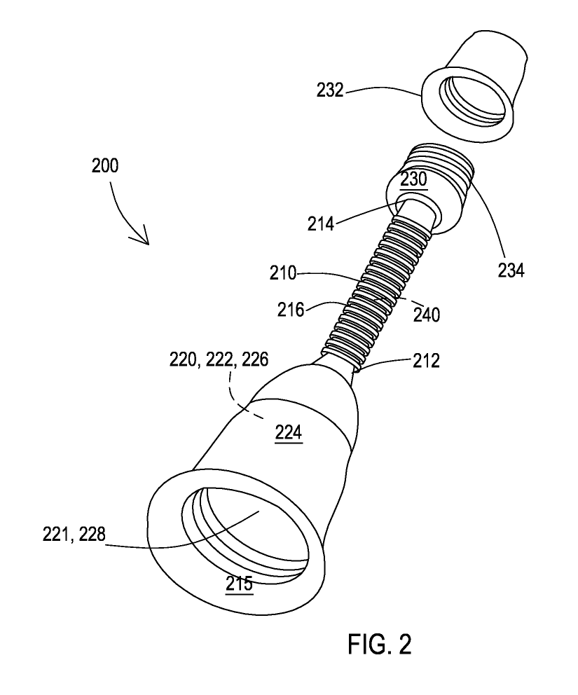

FIG. 2 illustrates a front perspective view of a gooseneck floodlight extension 200, in accordance with one embodiment of the present invention.

The gooseneck floodlight extension 200 includes a flexible gooseneck 210, a female light socket 220, a male light base 230 and one or more electrical wires 240. The flexible gooseneck 210 includes a first end 212 and a second end 214. The flexible gooseneck 210 allows a user to bend the gooseneck floodlight extension 200 to position a light 215 emitted from the gooseneck floodlight extension 200. The flexible gooseneck 210 is made with a first weather resistant cover 216 such as metal, stainless steel, plastic or other suitable material to protect the flexible gooseneck 210. The female light socket 220 is a standard female light socket 222 with a second weather resistant cover 224 attached to a first end 212 of the flexible gooseneck 210 to protect the female light socket 220.

The female light socket 220 receives a light bulb 221 that emits the light 215 emitted from the gooseneck floodlight extension 200. The female light socket 220 can be a standard female light socket (not shown) that receives a standard light bulb (not shown), an liquid crystal diode or LED female light socket 226 that receives an liquid crystal diode or LED light bulb 228, or any suitable female light socket that receives any suitable light bulb. The female light socket 220 can be made of porcelain or any other suitable material. The male light base 230 is attached to the second end 214 of the flexible gooseneck 210. The male light base 230 is screwed into a floodlight socket 232 and receives electric power from the floodlight socket 232. The male light base 230 is provided with a third weather resistant cover 234 such as metal, stainless steel, plastic or other suitable material to protect the male light base 230. The one or more electrical wires 240 are connected to the male light base 230 and the female light socket 220. The one or more electrical wires 240 transfer electrical energy from the male light base 230 and to the female light socket 220 that emits the light 215 emitted from the gooseneck floodlight extension 200. The gooseneck floodlight extension 200 is approximately 26 cm in length when fully extended but can be any suitable length.

While the present invention has been related in terms of the foregoing embodiments, those skilled in the art will recognize that the invention is not limited to the embodiments described. The present invention can be practiced with modification and alteration within the spirit and scope of the appended claims. Thus, the description is to be regarded as illustrative instead of restrictive on the present invention.

What is claimed is:

1. A gooseneck floodlight extension, comprising:
a flexible gooseneck that includes a first end and a second end, the flexible gooseneck allows a user to bend the gooseneck floodlight extension to position a light emitted from the gooseneck floodlight extension;
a female light socket attached to the first end of the flexible gooseneck, the female light socket receives a light bulb that emits the light emitted from the gooseneck floodlight extension and includes a first weather resistant cover to protect the female light socket;
a male light base attached to the second end of the flexible gooseneck, the male light base is screwed into a floodlight socket and receives electric power from the floodlight socket and is provided with a second weather resistant cover to protect the male light base; and
one or more electrical wires connected to the male light base and the female light socket, the one or more electrical wires transfer electrical energy from the male light base and to the female light socket to light the light bulb in the female light socket.

2. The gooseneck floodlight extension according to claim 1, wherein the flexible gooseneck is made with a third weather resistant cover to protect the flexible gooseneck.

3. The gooseneck floodlight extension according to claim 2, wherein the third weather resistant cover is made of a material selected from the group consisting of metal, stainless steel or plastic.

4. The gooseneck floodlight extension according to claim 1, wherein the female light socket is an E-27 standard female light socket.

5. The gooseneck floodlight extension according to claim 4, wherein the E-27 standard female light socket receives an E-27 standard light bulb.

6. The gooseneck floodlight extension according to claim 1, wherein the first weather resistant cover is made of a material selected from the group consisting of metal, stainless steel or plastic.

7. The gooseneck floodlight extension according to claim 1, wherein the second weather resistant cover is made of a material selected from the group consisting of metal, stainless steel or plastic.

8. A gooseneck floodlight extension, comprising:
a flexible gooseneck that includes a first end and a second end, the flexible gooseneck allows a user to bend the gooseneck floodlight extension to position a light emitted from the gooseneck floodlight extension, the flexible gooseneck is made with a first weather resistant cover to protect the flexible gooseneck;
a female light socket attached to the first end of the flexible gooseneck, the female light socket receives a light bulb that emits the light emitted from the gooseneck floodlight extension and includes a second weather resistant cover to protect the female light socket;
a male light base attached to the second end of the flexible gooseneck, the male light base is screwed into a floodlight socket and receives electric power from the floodlight socket and is provided with a third weather resistant cover to protect the male light base; and
one or more electrical wires connected to the male light base and the female light socket, the one or more electrical wires transfer electrical energy from the male light base and to the female light socket to light the light bulb in the female light socket.

9. The gooseneck floodlight extension according to claim 8, wherein the first weather resistant cover is made of a material selected from the group consisting of metal, stainless steel or plastic.

10. The gooseneck floodlight extension according to claim 8, wherein the female light socket is an E-27 standard female light socket.

11. The gooseneck floodlight extension according to claim 10, wherein the E-27 standard female light socket receives an E-27 standard light bulb.

12. The gooseneck floodlight extension according to claim 8, wherein the female light socket is an LED female light socket.

13. The gooseneck floodlight extension according to claim 12, wherein the LED female light socket receives an LED light bulb.

14. The gooseneck floodlight extension according to claim 8, wherein the first weather resistant cover is made of a material selected from the group consisting of metal, stainless steel or plastic.

15. The gooseneck floodlight extension according to claim 8, wherein the second weather resistant cover is made of a material selected from the group consisting of metal, stainless steel or plastic.

16. A gooseneck floodlight extension, comprising:
a flexible gooseneck that includes a first end and a second end, the flexible gooseneck allows a user to bend the gooseneck floodlight extension to position a light emitted from the gooseneck floodlight extension, the flexible gooseneck is made with a first weather resistant cover to protect the flexible gooseneck;
a female light socket attached to the first end of the flexible gooseneck, the female light socket receives a light bulb that emits the light emitted from the gooseneck floodlight extension, the female light socket includes a second weather resistant cover to protect the female light socket and the female light socket is a selected one of an E-27 standard female light socket and an LED female light socket;
a male light base attached to the second end of the flexible gooseneck, the male light base is screwed into a floodlight socket and receives electric power from the floodlight socket and is provided with a third weather resistant cover to protect the male light base; and
one or more electrical wires connected to the male light base and the female light socket, the one or more electrical wires transfer electrical energy from the male light base and to the female light socket to light the light bulb in the female light socket.

17. The gooseneck floodlight extension according to claim 16, wherein the first weather resistant cover, the second weather resistant cover and the third weather resistant cover are made of a material selected from the group consisting of metal, stainless steel or plastic.

18. The gooseneck floodlight extension according to claim 16, wherein the female light socket receives a selected one of an E-27 standard light bulb and an LED light bulb.

19. The gooseneck floodlight extension according to claim 16, wherein the female light socket is made of porcelain.

20. The gooseneck floodlight extension according to claim 16, wherein the gooseneck floodlight extension is approximately 26 cm in length when fully extended.
